(19) United States
(12) Patent Application Publication
(10) Pub. No.: US 2012/0299748 A1
(43) Pub. Date: Nov. 29, 2012

(54) Promotional vehicle audio system

(76) Inventor: David W. Reid, Beverly Hills, MI (US)

(21) Appl. No.: 13/068,929

(22) Filed: May 24, 2011

(51) Int. Cl. B60Q 5/00

(52) U.S. Cl. 340/902

(57) ABSTRACT

This invention relates to the field of motor vehicle audio systems. Specifically, this invention uses a voice synthesizer to play a horn tone “Jeep, Jeep” imitating the “Beep, Beep” voice, cadence, and rhythm of the Road Runner®. This is specific to the Jeep® brand and enables the user to either use the existing factory horn, or a separate loudspeaker to play the new horn tone as desired. The main elements of the system are a voice synthesizer, a loudspeaker, and an engagement device mounted on or near the steering wheel, which will operate the voice synthesizer and can be used to project the promotional message, “Jeep, Jeep” via the vehicle horn.

### FIELD OF THE INVENTION

The present invention relates to an audio system for a vehicle and more particularly to a system for playing a pre-recorded promotional message through the vehicle horn system.

### BACKGROUND OF THE INVENTION

Various prior art discloses vehicle horns that have multiple applications.
U.S. Patent Document No. 20080114904 (Kosco) discloses a sounding custom motor vehicle horn tones device that enables a user to sound custom motor vehicle horn tones for alerting, locating and other purposes. The main elements of the system are a horn tones audio player, a portable memory device and a remote computer. The player enables the user to sound custom horn tones while the remote computer and the portable memory device operate together to both download new horn tones files from a horn tones website and transport the new horn tones files to the horn tones audio player.
U.S. Pat. No. 6,489,886 (Meier) discloses a security system to prevent unauthorized starting of the engine of a vehicle has a remote control unit equipped with a transponder which, on reception of an interrogation signal using at least one reception aerial, transmits an identification code group using a transmitter unit. Located in the vehicle is a control unit, which on actuation of a starter button within the vehicle, transmits the interrogation signal, and subsequently checks the identification code group transmitted by the remote control unit. Starting of the engine will only be possible when the identification code group coincides with the code group expected by it. Connected to the reception aerial is a signal detector, which has a reaction threshold level that can be toggled between a high value and a low value.

The primary objective of the promotional vehicle audio system of the present invention is to provide a playback system for a pre-recorded promotional message in advertising campaigns, events, festivities, and parades, and enable the end-user to record and playback messages and music as needed.

### SUMMARY OF INVENTION

The promotional vehicle audio system of the present invention addresses this objective.

The present invention relates to a vehicle horn comprising a remotely mounted steering wheel button, a voice synthesizer, and a loudspeaker used to play a Jeep® brand specific recording “Jeep Jeep” in the cadence of voice of the Road Runner® with varying pitches as desired by the user. More specifically, the user will also be able to record greetings to be played immediately after the “Jeep, Jeep”.

A first preferred embodiment of the promotional vehicle audio system of the present invention comprises a vehicle horn for alerting traffic and other vehicles of an alarm condition when engaged by the driver of the vehicle. The promotional vehicle audio system also includes a device for engaging a pre-recorded promotional message. The engaging device is positioned in or near the steering wheel (12) and the pre-recorded promotional message is initiated upon activation of the engaging device.

A second preferred embodiment of the promotional vehicle audio system of the present invention comprises a vehicle horn for alerting traffic and other vehicles of an alarm condition, a device for engaging a pre-recorded promotional message, and a voice synthesizer. The engaging device is positioned in or near the steering wheel (12) and the pre-recorded promotional message is initiated upon activation of the engaging device. The voice synthesizer enables the driver to add additional messages and text to the promotional vehicle audio system of the present invention.

It will also be understood the use of ‘electric speaker’ will be understood by those skilled in the art to also be an electronic speaker, recognizing here the interchangeability of the words electric and electronic for the consumer product discussed.

For a complete understanding of the promotional vehicle audio system of the present invention, reference is made to the following summary of the invention detailed description and accompanying drawings in which the presently preferred embodiments of the invention are shown by way of example. As the invention may be embodied in many forms without departing from spirit of essential characteristics thereof, it is expressly understood that the drawings are for purposes of illustration and description only, and are not intended as a definition of the limits of the invention.

### BRIEF DESCRIPTION OF THE DRAWINGS

FIG. 1A depicts a first preferred embodiment of the promotional vehicle audio system of the present invention installed as original equipment in a Jeep vehicle.

FIG. 1B depicts a second preferred embodiment of the promotional vehicle audio system of the present invention installed as after-market equipment in a Jeep vehicle.

FIG. 2 depicts a simplified flow schematic of the promotional vehicle audio system of the present invention installed as original equipment of FIG. 1A as original equipment.

FIG. 3 depicts a simplified flow schematic of the promotional vehicle audio system of the present invention installed as original equipment of FIG. 1B as aftermarket equipment.

FIG. 4 depicts the loudspeaker and the receiver of the promotional vehicle audio system of the present invention for FIGS. 1A and 1B.

### DETAILED DESCRIPTION OF THE PREFERRED EMBODIMENTS

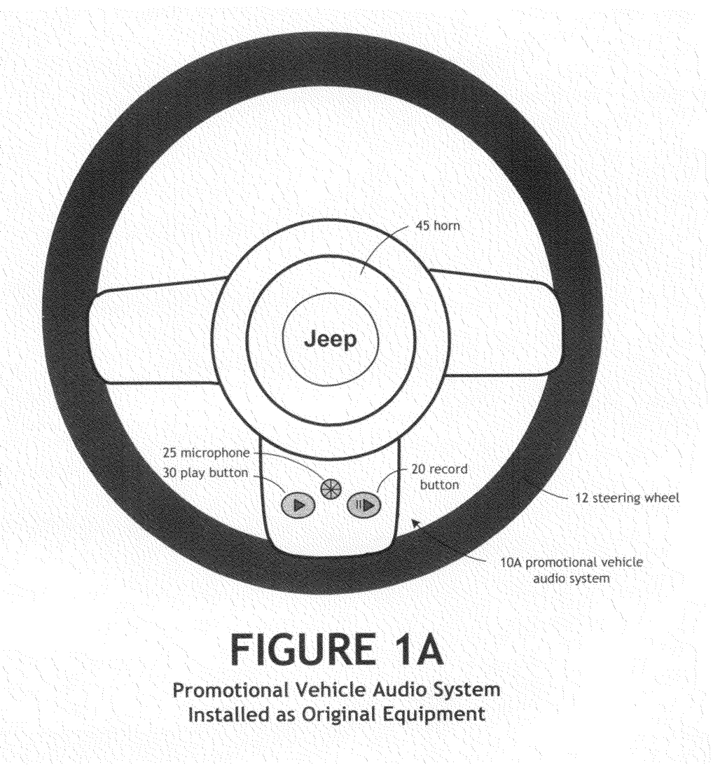

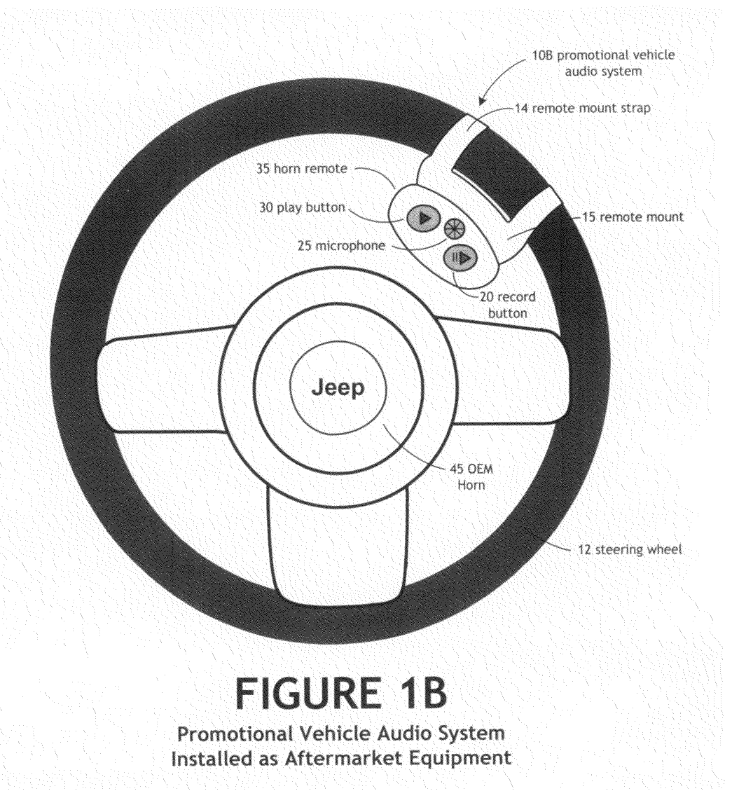

Referring now to the drawings, FIG. 1A discloses a first preferred embodiment of the promotional vehicle audio system (10A) of the present invention installed as original equipment in a Jeep vehicle.

The promotional vehicle audio system (10A) includes a play button (30) which is depressed for playing the “Jeep, Jeep” promotional message and other messages recorded by the vehicle driver, a microphone (25) for recording additional promotional messages, and the record button (20) for recording other promotional messages mounted in the spoke of the steering wheel (12). The synthesizer is located separate from the original equipment horn, enabling the use of the use of the original equipment horn in the case of emergencies. This configuration does not affect the use of the original equipment horn or its function in any way, enabling the user to use said horn in emergency situations to alert other drivers. In this preferred embodiment, the demonstrated placement of the buttons is for illustrative purposes, and could be mounted on the other spokes as best determined by the manufacturer. For example, while the user is at any number of Jeep promotional events, the promotional vehicle audio system (10A) of the present invention can be used by the manufacturer for playback of advertisements, or for vehicle drivers to add uniqueness to their own Jeep and to enable them to differentiate them from others and personalize their vehicle to their preferences.

FIG. 1B discloses a second preferred embodiment of the promotional vehicle audio system (10B) of the present invention installed as an aftermarket installation with the control unit (25) mounted to the rim of the steering wheel (12) in any place convenient to the vehicle operator. The control unit (25) is secured to the steering wheel (12) via a remote mount (15) and strap (10), enabling the user to remove the control unit (25) if so desired so as to record messages in addition to the promotional message, for example “Jeep, Jeep, Toot Your Own Horn”. The button layout includes the play button (30), the microphone (25) for recording messages, and the record button (20) for playing back recordings. The synthesizer is located inside the mounted control unit (35) and separate from the original equipment horn, enabling the use of the use of the original equipment horn in the case of emergencies. This embodiment enables the user to remove the horn control (35) and choose other mounting locations if so desired, for example using hook-and-loop-type fasteners to mount the control unit (35) to the dashboard if so desired.

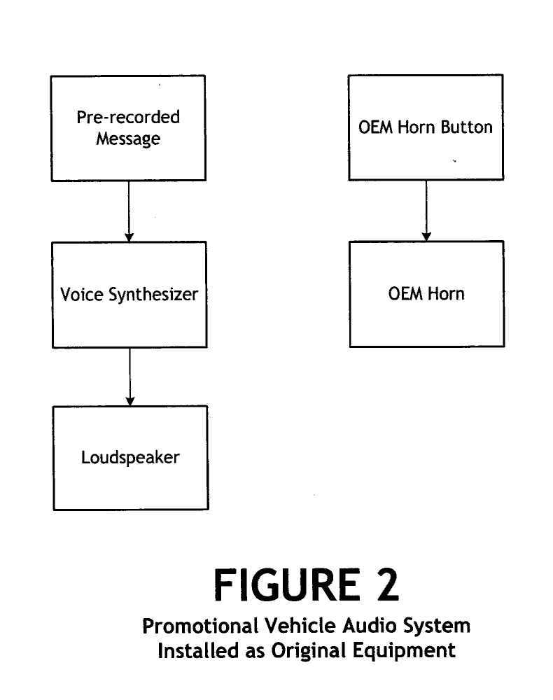

FIG. 2 depicts a simplified flow schematic of the promotional vehicle audio system (10A) of the present invention of FIG. 1A, installed as original equipment by Chrysler. This embodiment does not require the wireless receiver (51) since an original equipment installation enables the promotional vehicle audio horn (10A) to be hard wired directly to the horn (40) via the vehicle wiring harness.

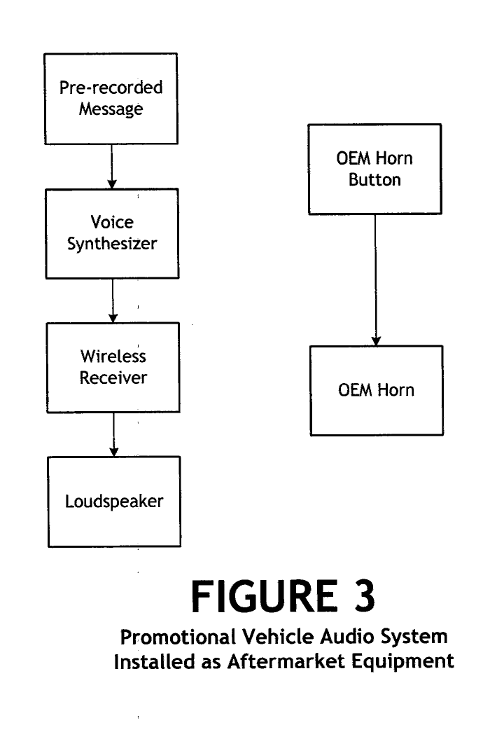

FIG. 3 depicts a simplified flow schematic of a second preferred embodiment of the promotional vehicle audio system (10B) of the present invention installed as an aftermarket installation. These components disclose the previously mentioned horn control (35) with synthesizer encased inside, play button (30), microphone (25), and record button (20), and the wireless receiver (51) which receives the signal containing the promotional message from the steering wheel mounted horn control (35) which is connected to the second horn (40). The wireless receiver may be mounted underneath the dashboard or anywhere convenient for connection to the horn by anyone skilled in the art. The horn (40) with mount (50) may be mounted anywhere in the engine compartment of the vehicle by one skilled in the art.

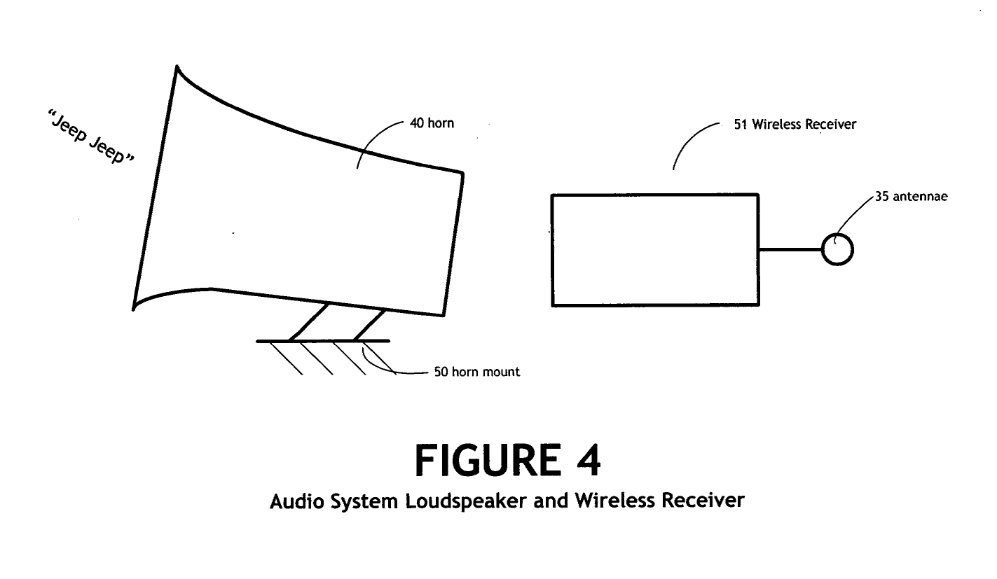

FIG. 4 discloses the horn (40), mount (50), wireless receiver (51), and antennae on the wireless receiver (35). The wireless receiver can be mounted anywhere in the vehicle cabin, for example: under the dashboard, in the glove box, within the center console, in the engine compartment near the horn (50), or in the engine compartment, as wanted by the car owner.

One preferred embodiment of the present invention relates to an installable and electronic speaker system having an electronic speaker, a voice synthesizer, a steering wheel mountable control module or switch, with the ability to record and playback user installed songs and sounds.

The horn is used to deliver a horn tone in the rhythm and sound of the road runner while at the same time enabling use and retainment of the OEM horn of a Chrysler® vehicle using a button placed on the steering wheel (12) and connected to a voice synthesizer which will then be connected to the horn or to a loud speaker which is in addition to the existing factory horn. In this manner, the driver will thusly be able to use either the regular horn button during emergency situations or use the other button to sound the “Jeep, Jeep” imitating the “Beep, Beep” voice, cadence, and rhythm of the Road Runner®.

The Jeep® brand currently produces five models: the Jeep Wrangler®, the Jeep Grand Cherokee®, the Jeep Liberty®, the Jeep Compass®, and the Jeep Patriot®. In another preferred embodiment of the promotional vehicle audio system of the present invention the tonal quality of the sound of the pre-recorded “Jeep, Jeep” will vary depending upon the model of the vehicle.

Throughout this application, various Patents and Applications are referenced by number and inventor. The disclosures of these documents in their entireties are hereby incorporated by reference into this specification in order to more fully describe the state of the art to which this invention pertains.

It is evident that many alternatives, modifications, and variations of the promotional vehicle audio system of the present invention will be apparent to those skilled in the art in light of the disclosure herein. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

1. A promotional vehicle audio system, comprising:
a vehicle horn for alerting traffic and other vehicles of an alarm condition, the vehicle horn being disposed within the steering wheel; and
a device for engaging a pre-recorded promotional message, the engaging device being disposed in or near the steering wheel, the pre-recorded promotional message being initiated upon activation of the engaging device;
whereby the pre-recorded promotional message includes the word term “Jeep, Jeep”.

2. The promotional vehicle audio system of claim 1, wherein the sound of the promotional message imitates the voice and the cadence of a Road Runner® cartoon character voicing “Jeep, Jeep” .

3. A promotional vehicle audio system, comprising:
a vehicle horn for alerting traffic and other vehicles of an alarm condition;
a voice synthesizer that enables a driver to project his or her voice outside the vehicle, the voice projection being in audible tones; and
a device for engaging a pre-recorded promotional message, the engaging device being disposed in or near the steering wheel, the pre-recorded promotional message being initiated upon activation of the engaging device;
whereby the pre-recorded promotional message includes the word “Jeep”.

4. The promotional vehicle audio system of claim 1, wherein the pre-recorded promotional message imitates the voice and the cadence of a Road Runner® cartoon character.

5. A promotional vehicle audio system, comprising:
a vehicle horn for alerting traffic and other vehicles of an alarm condition;
a voice synthesizer that enables a driver to project his or her voice outside the vehicle, the voice projection being in audible tones; and
a device for engaging a pre-recorded promotional message, the engaging device being disposed in or near the steering wheel, the pre-recorded promotional message being initiated upon activation of the engaging device, the pre-recorded promotional message including the term “Jeep, Jeep”.

6. The promotional vehicle audio system of claim 5, further comprising a loud speaker in addition to the vehicle horn.

7. The promotional vehicle audio system of claim 5, wherein a button is disposed in the center, or on the perimeter of the wheel.

8. The promotional vehicle audio system of claim 5, wherein the sound of the promotional message imitates the voice and the cadence of a Road Runner® cartoon character voicing “Jeep, Jeep”.
